(19) United States
(12) Patent Application Publication
(10) Pub. No.: US 2010/0288602 A1
(43) Pub. Date: Nov. 18, 2010

(54) DEVICE FOR OPENING A COVER LEAF OR COVER OF A BOUND PUBLICATION

(75) Inventor: Clause Pfankuch, Hamburg (DE)

Correspondence Address: SAND & SEBOLT, AEGIS TOWER, SUITE 1100, 4940 MUNSON STREET, NW, CANTON, OH, 44718-3615, US

(73) Assignee: PFANKUCH MASCHINEN GMBH, Ahrensburg (DE)

(21) Appl. No.: 12/812,648

(22) PCT Filed: Jan. 15, 2009
(86) PCT No.: PCT/EP2009/050453

§ 371 Date: Jul. 13, 2010

(30) Foreign Application Priority Data
Jan. 23, 2008 (DE) 20 2008 000 998.7

(51) Int. Cl. B65G 47/22

(52) U.S. Cl. 198/345.1

(57) ABSTRACT

In order to improve a device (1) for opening a cover leaf or cover of a magazine, a book, or a comparable bound publication to be disposed in the area of a linear conveyor unit such that it allows rapid and flexible opening of a cover leaf or cover of a publication independently of the clocking of the supply of said publications, it is proposed by the invention that such a device (1) has a guide face (22), which is oriented in its longitudinal direction substantially along a conveyance direction of the linear conveyor unit and faces toward the latter, and which runs, starting from an area (23) at minimal distance to the linear conveyor unit, inclined at increasing distance to the linear conveyor unit, wherein at least one suction opening (25) for applying a partial vacuum is disposed in the active section (24), the suction opening extending in the longitudinal direction of the guide face (24), and wherein at least one conveyor band or conveyor belt, which runs over said guide face (24) in its longitudinal direction, is provided, through which or past which the partial vacuum acts on the cover leaf or the cover of a magazine, a book, or a comparable publication moved on the linear conveyor unit in the area of active section, wherein the drive velocity of said conveyor band or conveyor belt can be synchronized with the conveyance velocity of said linear conveyor unit.

### TECHNICAL AREA

The invention concerns a device for the opening of a cover leaf or cover of a magazine, a book or a comparable, bound publication to be disposed in the area of a linear conveyor unit.

### PRIOR ART

It is common, in particular in the context of magazines, but also in the case of books or bound publications or printed products it is usual, to insert into the book, the magazine, the booklet or such like supplements, for example advertising leaflets or brochures. Today this is already extensively performed automatically. While the enclosure of a supplement at any location in the middle of the printed product is implemented comparatively simply, in this context the printed product is opened at any location by means of the insertion of a partition plate and the supplement is placed, the printed product is subsequently closed again, the insertion of the supplement specifically below the cover leaf or cover requires a higher degree of effort on the part of the equipment. Exactly at this location, meaning in the very front of the printed product, enclosed supplements are however of particular interest. With these higher sales can for example be achieved in the advertising industry because the advertising supplement effectively “jumps out” at the user of the publication immediately during the opening of the same. This is the reason advertising customers pay correspondingly higher amounts for advertising supplements positioned at this location.

In order to be able to insert a supplement specifically below the cover leaf or cover of a publication, only that cover leaf or the cover of the finished publication must be reliably lifted and the publication be opened at this location. Appropriate machines are utilized for that purpose already today. In this context machines are known that work with vacuum and suction devices. With such a known device an extension arm, at the end of which a suction head is disposed, circulates around a rotational axis that runs vertically to a longitudinal conveyor belt, where the revolution of the rotational axis is coupled with the drive of the linear conveyor belt by means of correspondingly synchronized transmissions. The linear conveyor belt is thereby implemented as a studded conveyor belt where the front edges of the publications abut respectively against one of the studs that are implemented in the conveyor band. These studs are required in order to correctly maintain the clocking of the printed products in the supply to the suction device. If a printed product that abuts against a stud from behind, for example a booklet or magazine, draws near to the suction device, the boom with the suction head that is attached at its end approaches, synchronous with the studded conveyor belt, the front edge of the cover leaf, takes hold of it by means of applied vacuum and lifts it by means of the continued rotational movement upward. The vacuum applied at the suction head is thereby controlled in such a manner that it is turned off at a certain height of the suction device so that the cover leaf is released and is not subject to the possible threat of being torn off by the continuing conveyance.

While this known device does permit an automated and reliable opening of the cover leaf and thereby the insertion of supplements below the cover leaf by means of downstream machines and devices, it does however feature various inadequacies. In particular said known device is dependent, because of the required coupling between the studded conveyor belt and the drive for the rotating extension arm with suction head, on the exact conveyance of the publications into the studded conveyor belt. This purpose is provided by the studs that are to assure the exact alignment of the front edges of the publications, on which the cover leafs are to be taken hold of by the suction device. If the publication is not placed exactly on the studded conveyor belt, errors occur.

Furthermore the utilization of this device with different publications of the most different formats is not readily possible because the spacings of the studs in the studded conveyor belt limit the possible publication formats. In other words, differently dimensioned studded conveyor belts have to be provided for different publication formats that then have to be, as the case may be, re-equipped during a change-over of the machine. Finally a simple retrofit of this device or an installation of the same into existing conveyor systems is not readily possible, at least not if these existing conveyor systems do not feature studded conveyor belts.

### DISCLOSURE OF THE INVENTION

Correspondingly the invention is to provide a remedy. In particular it is the object of the invention to indicate a device of the kind referred to initially that permits a quick and flexible opening of the cover leaf or cover of a publication independently of the clocking of the conveyance of the publications.

This problem is solved by means of the device with the characteristics of the protective claim 1. Advantageous improvements are provided in the dependent sub-claims 2 to 15.

Essential for the device according to the invention for the opening of a cover leaf or cover of a bound publication for the purposes of the disposition in the area of a linear conveyor unit is the combination of the guide face with the conveyor band or conveyor belt, which runs over said guide face, as well as the suction opening and the oblique course of the guide face in the area of the suction opening. Furthermore it is important that the drive velocity of the conveyor band or conveyor belt can be synchronized with the conveyance velocity of the linear conveyor unit.

By means of the device according to the invention that was sketched as indicated above and the embodiment provided in detail in the claim in the characteristics it is possible that the cover leaf, and indeed specifically only it, of a publication that is approaching on a linear conveyor unit and progressing underneath the device according to the invention, is taken a hold of and opened by means of the vacuum applied by the suction opening. Thereby the conveyor band, which is synchronized with the conveyance velocity of the linear conveyor unit in regard to its drive velocity, assures a further movement, which is in unison with this conveyance velocity, of the cover leaf, which is progressing up the obliquely designed guided face and held by the vacuum, without the possible threat of being torn off. At the end of the guide face the cover leaf is then opened sufficiently far or separated from the remaining pages of the publication and can be transferred to a mechanical hold-open device (compare claim 14) be thereby held open. Subsequently for example a supplement can be inserted into the publication opened by these means by a separate device and the publication can be closed again outside of the device according to the invention.

It should be obvious that various advantages are associated with the embodiment of the device according to the invention as described above. Due to the effectively continuous operation of the conveyor band or belt the utilization of a studded conveyor belt in the linear conveyor unit, which was required in the context of the previously known device of the type according to the preamble for a correct positioning and a thusly positioned delivery of the publications to the suction device utilized there, is no longer necessary. Rather the device according to the invention can be deployed with any linear conveyor unit, in particular with common conveyor bands with a smooth surface. In particular it is thereby possible to process publications of the most different formats with the device according to the invention without someone having to undertake an effort-intensive refitting of the linear conveyor unit by himself (exchange of the studded conveyor belt) for that purpose.

The synchronization of the drive velocity of the conveyor band or the conveyor belt with the conveyance velocity of the linear conveyor unit can be implemented by means of a mechanical pickup or, if necessary, by means of the interconnection of a corresponding transmission gear. Preferably however a control is used for this purpose that is advantageously a component of the device according to the invention (compare claim 2). This control is fed the data regarding the conveyance velocity of the linear conveyor unit, for example by a corresponding control of the linear conveyor unit or by a velocity sensor and determines there from, if necessary taking into account an angle of the active section to the linear conveyor unit, the drive velocity of the conveyor band or conveyor belt in a manner that a secure and guided further transport of the suctioned cover or cover leaf is assured.

A punched belt with openings that are disposed at regular intervals can for example be used as a conveyor band or conveyor belt, whereby the vacuum from one of several suction openings is applied to the cover leaf or the cover through these opening or holes. Alternatively it is also possible to leave the suction opening or suction openings open and to guide the conveyor bands or conveyor belts laterally to the openings which in that case do not have to be penetrated by additional openings. In both cases it is prevented that the cover leaf or the cover of the publication gets into the active section in immediate contact with the guide face and is therefore sucked in and decelerated. Rather the cover leaf and the cover lay securely against the conveyor belt or the conveyor band and are conveyed on by the same in a manner synchronized with the conveyance velocity of the conveyor unit.

As was already mentioned, the suction opening can be implemented in the shape of a single opening that extends over the active section in its longitudinal direction as an oblong hole. Likewise beneficial it is in this context conceivable that two or more openings, in particular a plurality, are provided that form a row as circular openings or as extended openings in the longitudinal direction along the active section of the guide face.

Conveyor band or conveyor belt can be advantageously implemented as endless belts or endless bands and circulate around guide rollers.

Furthermore it is of an advantage if in the area of the guide face that is facing the active section in the longitudinal direction of the guide face a run-on bevel is implemented in which the guide face, starting from a point with the largest distance to the linear conveyor unit, is inclined to the area with minimal distance to the linear conveyor unit. By these means it is assured that the approaching publications are completely below the device according to the invention, more precisely below the guide face, when getting into the active section and therefore the cover or the cover leaf is securely and reliably taken hold of and opened.

Preferably the guide face is, with the exception of the suction opening(s) as well as at least a vacuum connection for the connection to a device for generating a vacuum, part of a tightly sealed vacuum chamber. This is the simplest and most reliable variation to apply a sufficient vacuum for example by means of a low-pressure or vacuum pump to the suction openings, namely by means of the vacuum connection.

A movable and flexible bearing support of the guide face, as indicated in claim 10, that is essentially vertical to the conveyance direction of the linear conveyor unit permits, especially in combination with the run-up bevel described above, a flexible swerving by the device according to the invention in the case of stronger publication being supplied as well as the application of a certain and dosed contact pressure onto the cover leaf or the cover of the publication for the specific lifting of said cover in the area of the active section.

A measure of the flexibility the device according to the invention obtains when it features an adjustment provision for the adjustment of the distance between the guide face and the linear conveyor unit. This permits a simple adaptation of the device to the publications of different strength to be processed, by simply changing said distance with the adjustment provision. Thereby the device can process for example comparatively thin magazines, by means of which this distance is adjusted smaller; thicker books require a larger distance that can be adjusted with the adjustment provision according to the invention. A further degree of freedom is obtained when, by means of the adjustment provision, not only the distance but also the tilt angle between the guide face of the linear conveyor unit, in particular the tilt angle in a projection onto the conveyance direction of the linear conveyor unit, can be adjusted. Such an adjustment of the tilt angle can of course be also implemented by means of a separate adjustment means without this constituting a deviation from the invention. By means of an adjustment of the tilt angle the slope angle of the guide face in the active section relative to the plane of the conveyor unit can in particular be set and be optimized in regard to the publication to be processed.

A further possibility of the implementation of the device according to the invention and the adaptation of the same to different publications to be processed results if the adjustment provision, as indicated in claim 12, is also laid out for the adjustment of a tilt angle of the guide face relative to the linear conveyor unit.

If the adjustment provision, as provided according to claim 13, also features a controllable motorized drive, the adaptation can be performed automatically. In this context it is also conceivable that a sensor is provided for the determination of the product strength of the publications, whose data are supplied to the controller, whereby the controller performs an automated adjustment of the adjustment provision based on these data.

In order to hold open the publication after the opening or lifting of the cover leaf or cover of the publication and to insert a supplement securely into the publication, the device according to the invention can feature a mechanical hold-open device that is disposed in an advantageous manner in relation to the conveyance direction of the linear conveyor downstream of the suction device (compare claim 14). This can for example be a rod, a guiding plate or such like.

Finally it is additionally of an advantage is the device according to the invention is implemented as an integral unit, as indicated in claim 15. This makes possible in particular the simple mounting of the device to existing linear conveyor units without that additional individual elements would have to be installed for that purpose, such as for example holding frames for individual components or suchlike.

The object of the invention is also a device for the individual dispensation of supplements into bound publications with a linear conveyor, a device as described above for the opening of a cover leaf or cover of a publication as well as, downstream of this device, a dispensation device for the individual dispensation of supplements into the publication with an opened cover.

This device can, and this a significant advantage of the device according to the invention in regard to the opening of the cover leaf or cover of a publication, handle and process publications securely that are supplied in irregular time and/or spatial intervals on the linear conveyor unit that in particular can be a conveyor band with smooth surface. For this purpose it is only required that publications that enter into the area of the—known as such in the embodiment—dispensation device are recognized by means of suitable sensor technology, for example light gates, and the dispensation device, clocked according to this approach, is activated and started up.

### BRIEF DESCRIPTIONS OF THE DRAWINGS

Additional advantages and characteristics of the invention are provided by the following descriptions of the figures in reference to the enclosed figures. It is thereby shown:

FIG. 1 a schematic perspective view of a device according to the invention;

FIG. 2 a schematic view of the device according to the invention from FIG. 1, viewed from a different angle;

FIG. 3 a schematic three-dimensional view of a part of the device according to the invention (without the drive unit for the conveyor belt);

FIG. 4 a three-dimensional view of the assembly from FIG. 3, viewed from a different angle;

FIG. 5 a further reduced view for the illustration of the flexible bearing support;

FIG. 6 a view of the device according to FIG. 1, viewed from below at an oblique angle;

FIG. 7 a view as in FIG. 6 without the revolving punched belt; and

FIG. 8 in four different steps schematically the functioning or mode of operation of the device according to the invention during opening or lifting of a cover leaf or cover of a publication.

### WAY(S) OF IMPLEMENTING THE INVENTION

In the figures is presented and referenced with 1, in different view and partial views, an embodiment example for a device according to the invention for the opening of a cover leaf or cover of a magazine, a book or a comparable, bound publication. This device 1 is intended for the disposition in the area of a linear conveyor unit, more precisely expressed above the same, as is implied in particular by FIG. 8, which is described in more detail later.

The device comprises a box-like base frame 2 which is set in a receptacle 3, which is to be attached to a linear conveyor unit, and is to be variably adjustable in its position relative to said receptacle 3. For this purpose an oblong hole 5 is respectively formed in angle brackets 4 that are disposed u-shaped on both sides of the base frame 2, said slot is respectively penetrated by a threaded bolt that is firmly connected with the base frame 2 or is guided through the same and which features a smaller diameter than the width of the opening of the slot 5. The base frame 2 is set between the angle brackets 4 with tensioning screws 6 by means of contact forces. The base frame 2 can be lowered or raised relative to the receptacle 3 by means of loosening the tensioning screws 5, and a tilting about the axis of the threaded bolt can take place. Because of the fact that the threaded bolt is smaller in its diameter than the width of the opening of the slot 5 the possibility hereby arises as an additional degree of freedom of a (limited) for- and backward sliding of the base frame 2 along its longitudinal direction.

For the adjustment of the height of the base frame 2 relative to the receptacle 3 spacing screws 7 are provided that penetrate the base frame 2 with a thread and abut against a counter surface by means of a contact buffer 8 that is disposed on their end that faces the conveyor unit. The spacing of the contact buffer 8 relative to the base frame 2 is altered, increased or reduced by means of screwing and unscrewing the spacing screws 7 so that here in addition and precisely the spacing between base frame 2 and receptacle 3 and also the tilt angle of the base frame relative to the receptacle 3 can be prescribed before the base frame 2 is fixated relative to the receptacle 3 by means of tightening of the tensioning screws 6. Since the receptacle 3 in practice is installed fixed relative to the conveyor unit, the spacing of the base frame 2 and therefore all parts that are installed on it, and are still to be described later, can be adjusted relative to the conveyor unit by these means.

On the base frame 2 is disposed a vacuum box 10 by means of a boom 9. About this vacuum box 10 runs, via guide rollers 11 and a drive roller 12, a punched belt 13 that is implemented as an endless belt with openings or holes that are disposed in regular intervals. The same is set in motion and held by means of the drive roller 12 which is put into rotation by means of drive motor 15, which is also attached to the base frame 2, via force transmission means that are not illustrated in detail.

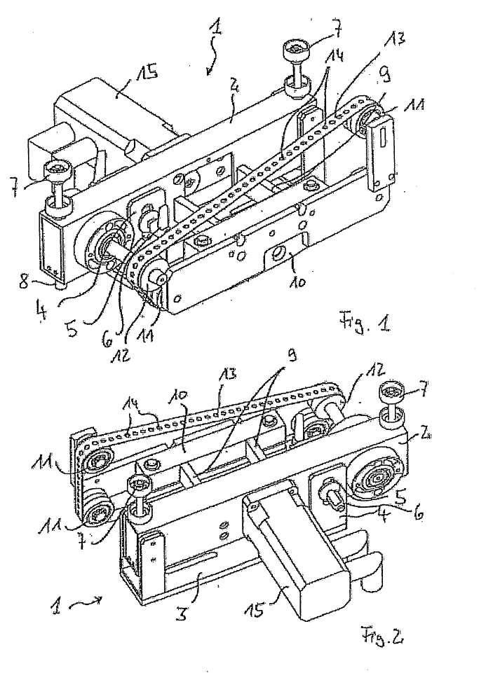

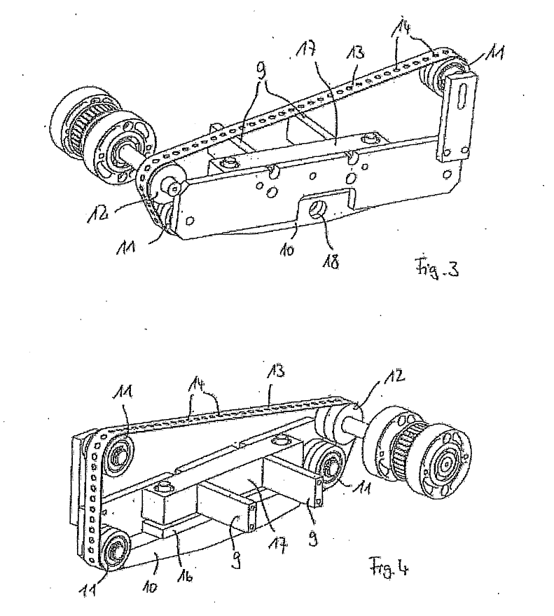

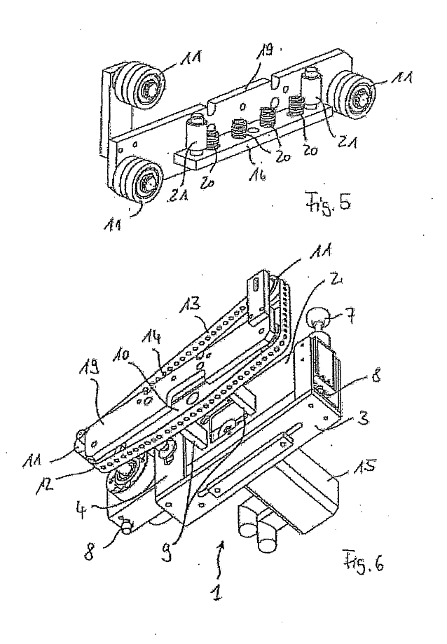

In the FIGS. 3 and 4 is represented, separate from the base frame 2 as a partial illustration, only the boom or the pair of booms 9 with the vacuum box 10 that is disposed or hung thereon and the punched belt 13 that circulates around the same.

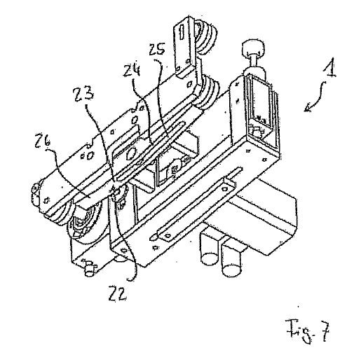

It can be recognized here that at the end of the boom 9 the vacuum box 10 is not attached directly but instead via a combination, formed by a bracing plate 16 and holding means 17, that, as will be explained in more detail later in reference to FIG. 5, serves to provide an flexible bearing support of the vacuum box 10.

Well recognizable here also is a connection opening 18, which is inserted into the vacuum box 10, for purposes of connection of a means for generating a vacuum, for example a low-pressure of vacuum pump, by means of corresponding connection elements such as hoses or suchlike.

In FIG. 5 is displayed in a reduced manner once again only the component assembly that essentially encompasses the bracing plate 16 and the three guide rollers, mounted on a longitudinal plate 19 that is standing vertically. Of primary importance to be recognized in this illustration are the coil springs 20, on which the holding means 17 abuts flexibly in the mounted state and is guided and secured against inadvertent lateral shifting by means of connection pins 21. By means of this connection and the intermediate layer of the coil springs 20 a flexible bearing support, which is essentially vertical to the linear conveyor unit, of the vacuum box is achieved.

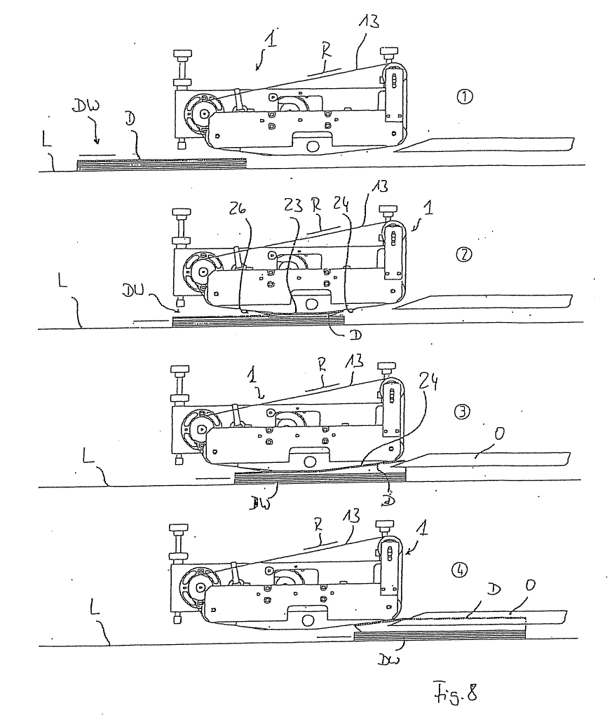

In FIG. 6 the entire arrangement of the device is shown once again from a perspective viewed obliquely from below, in this case with mounted circulating punched belt 13. In this illustration it is well recognizable that the punched belt 13 runs on the underside of the vacuum box 10, closely abutting against the same, whereby the guide face 22, which can be recognized in FIG. 7, which presents an illustration as in FIG. 6 but without the punch belt 13, extends along this underside. This guide face 22 lays in the mounted state facing the linear conveyor unit and features in an area 23 a minimal spacing to this linear conveyor unit. Viewed in the conveyance direction of the linear conveyor unit and also in the circulating direction of the punched belt 13 above the guide face 22, behind the area 23 extends an inclined active section 24 with a suction opening 25 that is implemented therein as an oblong hole or slot. In the area of the active section 24 the guide face 22 is implemented obliquely so that it runs at increasing distance to the linear conveyor unit in the case of the mounted device 1.

Beyond the area 23 and insofar facing the active section 24 a run-up bevel 26 is implemented in the guide face 22, said bevel runs, in the case of the mounted device 1, also inclined in regard to the linear conveyor unit, starting from a larger distance, subject to the reduction of this distance toward the area 23 in an inclined manner.

Over the entire guide face 22, meaning over the run-up bevel 26, the area 23, and the active section 24 runs the punched belt 13 tightly abutting and following its contour, as can be recognized in FIG. 6.

In FIG. 8 finally the mode of operation of the device according to the invention is presented schematically in four sequence representations. In the first and top-most sequence it is shown how a publication DW with a cover or cover leaf D approaches on a linear conveyor unit L, in the area of which or above which the device 1 according to the invention is disposed, said invention. The linear conveyor unit L can hereby for example be a simple conveyor band, if necessary with suction openings for holding the publication DW in a transport position relative to the conveyor band.

The circulating direction of the punched belt 13 is indicated with an arrow R at the device 1. In the second illustration from the top it is shown in a second sequence how the publication DW in the meantime has passed with its front edge the run-up bevel 26 and also the area 23 with the least distance of the guide face to the linear conveyor unit L and has entered the active section 24 with the suction opening. Because of the vacuum applied by means of the suction opening to the cover or the cover leaf D of the publication DW, the first is held and lifted and pulled against the punched belt 13 through whose openings the vacuum takes effect. In the next sequence illustration is can be recognized that the publication DW has been conveyed on in the meantime with the cover or cover leaf D that is, as before, sucked in and pulled against the punched belt 13 due to the vacuum in the active section 24. A synchronization between the drive velocity of the punched belt 13 and the conveyance velocity of the linear conveyor unit L assures thereby that the cover or the cover leaf D of the publication DW is not possibly bent or even torn off but is conveyed along, via the punched belt 13, securely and matched to the conveyance velocity of the linear conveyor unit L.

Already in this sequence, better still in the next and the last represented sequence, it can be recognized that the opened cover or the cover leaf D of the publication is pushed in the area of the end of the guide face across an hold-open device O that can be implemented for example in the shape of a simple plate made from metal or plastic with an oblique front edge. In the forth represented sequence the cover D of the publication DW is held by means of the vacuum only just in the rearmost area in the active section 24 of the guide face 22, during the course of a further circulating movement of the punched belt 13 and simultaneous conveyance of the linear conveyor unit L this section also is transferred from the device 1 according to the invention to the hold-open device O, the cover or cover leaf D of the publication DW is opened or lifted and supplements, brochures or such like can be inserted at this location into the publication At the same time additional publications can now be supplied (not shown here) to the device for corresponding processing.

The device according to the invention is suitable for the continuous operation for the secure and reliable opening of specifically only the cover leaf or cover of a publication with high clocking speed. In particular the device can be simply mounted to already existing linear conveyor units and be integrated in to such conveyor systems without that a significant re-equipping effort is required for this purpose. It must only be assured that a synchronization or a matching of the drive velocity of the punched belt with the conveyance velocity of the linear conveyor unit is implemented.

The hold-open device O can thereby be a component of the device according to the invention, it can however be disposed separately without being immediately attributable to the device according to the invention.

### LIST OF REFERENCE SYMBOLS

1 Device

2 Base frame

3 Receptacle

4 Angle brackets

5 Oblong hole

6 Tensioning screw

7 Spacing screw

8 Contact buffer

9 Boom

10 Vacuum box

11 Guide roller

12 Drive roller

13 Punched belt

14 Opening

15 Drive motor

16 Bracing plate

17 Holding means

18 Connection opening

19 Longitudinal plate

20 Coil springs

21 Connection pin

22 Guide face

23 Area

24 Active section

25 Suction opening

26 Run-up bevel

D Cover, cover leaf

DW publication

L linear conveyor unit

O hold-open device

R circulating direction

1. A device for the opening of a cover leaf or cover of a bound publication for disposition in the area of a linear conveyor unit, the device comprising a guide face aligned in its longitudinal direction primarily along the conveyance direction of the linear conveyor unit and facing the same that, viewed in the conveyance direction starting from an area with minimal distance to the linear conveyor unit in an active section, runs inclined with increasing distance to the linear conveyor unit, whereby in the active section for application of a vacuum at least one suction opening is disposed that extends in the longitudinal direction of the guide face and whereby at least one conveyor belt is provided that runs across the guide face in its longitudinal direction, through said belt or passed which the vacuum takes effect on the cover leaf or the cover of the bound publication which is moved on the linear conveyor unit in the area of the active section, and wherein the drive velocity of the conveyor belt is synchronized with the conveyance velocity of the linear conveyor unit.

2. The device according to claim 1, wherein a control is provided for the synchronization of the drive velocity of the conveyor belt with the conveyance velocity of the linear conveyor unit.

3. The device according to claim 1, wherein the conveyor belt is a punched belt with openings disposed along the longitudinal direction at regular intervals, and this punched belt with the openings is placed and runs across the at least one suction opening.

4. The device according to claim 1, further comprising a second conveyor belt, and wherein the two conveyor belts run on either side of the at least one suction opening in the longitudinal direction of the guide face.

5. The device according to claim 1, wherein in the active section only a single suction opening is provided, and the single suction opening is an oblong hole that runs in the longitudinal direction of the guide face.

6. The device according to claim 1, wherein in the active section a plurality of suction openings are provided and the suction openings are disposed in series in the longitudinal direction.

7. The device according to claim 1, wherein the at least one conveyor belt is implemented in an endless mode and circulates by means of guide rollers.

8. The device according to claim 1, wherein in an area of the guide face that is facing the active section in a direction opposite the conveyance direction of the linear conveyor unit a run-up bevel is provided in which the guide face runs, starting from a position of larger distance to the linear conveyor unit, inclined until the area with minimal distance to the linear conveyor unit.

9. The device according to claim 1, wherein the guide face is, with the exception of the at least one suction opening as well as at least one vacuum connection for the connection with a device for generating a vacuum, part of a tightly sealed vacuum chamber.

10. The device according to claim 1, further comprising a flexible bearing support provided on of the guide face, and the bearing support is movable in an essentially vertical direction relative to the conveyance direction of the linear conveyor unit.

11. The device according to claim 1, further comprising an adjustment provision for the adjustment of the distance between the guide face and the linear conveyor unit.

12. The device according to claim 11, wherein the adjustment provision is in addition equipped for the adjustment of a tilt angle between the guide face and the linear conveyor unit.

13. The device according to claim 11, wherein the adjustment provision features a controllable motorized adjustment drive.

14. The device according to claim 1, further comprising a mechanical hold-open device that is disposed in relation to the conveyance direction of the linear conveyor downstream of the suction device for the purpose of holding open the opened cover leaf or cover.

15. The device according to claim 1, wherein the device is an integral unit that is affixed laterally to an existing linear conveyor unit.

16. A device for the individual dispensation of supplements into bound publications, comprising a linear conveyor unit, a device for the opening of a cover leaf or cover of a publication according to claim 1 as well as, downstream of this opening device, a dispensation device for the individual dispensation of supplements into the publication with the opened cover.

17. The device according to claim 1, wherein the conveyor belt has an upper surface upon which the publication rests and the upper surface of the conveyor belt is substantially smooth and free of studs.
